(19) United States
(12) Patent Application Publication
(10) Pub. No.: US 2008/0260269 A1
(43) Pub. Date: Oct. 23, 2008

(54) Repetition and Correlation Coding

(75) Inventor: Arvind Thiagarajan, Tamil Nadu (IN)

Correspondence Address: KNOBBE MARTENS OLSON & BEAR LLP, 2040 MAIN STREET, FOURTEENTH FLOOR, IRVINE, CA, 92614, US

(73) Assignee: Matrixview Limited

(21) Appl. No.: 12/094,599

(22) PCT Filed: Nov. 22, 2005
(86) PCT No.: PCT/SG2005/000398

§ 371 Date: May 21, 2008

(51) Int. Cl. G06K 9/36

(52) U.S. Cl. 382/238

(57) ABSTRACT

A method for compressing image data of an image wherein a difference between each element and a previous element is calculated (303), the method comprising: comparing (304) the difference with a pre-determined correlation value; if they are equal, a first value is recorded into a bit plane (308), where the pre-determined correlation value is associated with the bit plane (305); and if they are not equal, a second value is recorded into the bit plane (309). Where a first value is recorded in the bit plane, the value of the element is not stored (310), where there is a second value in the bit plane, the value of the element is stored (311). The compressed image can be decompressed using both the bit plane and the bit plane index.

### CROSS-REFERENCE TO RELATED APPLICATIONS

Title: REPETITION CODED COMPRESSION FOR HIGHLY CORRELATED IMAGE DATA

Application No.: PCT/IN03/00049 Filed: 7 Mar. 2003

Inventor: Arvind Thiagarajan

Title: COMPRESSING IMAGE-DATA

Application No.: PCT/SG22004/000411 Filed: 15 Dec. 2004

Inventor: Arvind Thiagarajan

### TECHNICAL FIELD

The invention concerns a method for compressing image data of an image.

### BACKGROUND OF THE INVENTION

Repetition Coded Compression (RCC) is a technology invented by the present inventor to increase compressibility of data. RCC is disclosed in the two previously filed cross-related applications, the contents of which are herein incorporated by reference.

RCC achieves a very impressive level of compression based on coding repetitions. For example, consider this data sequence of pixel values, where each pixel is represented by 8 bits:

| | Data Sequence: | | | | | | | | |
|---|---|---|---|---|---|---|---|---|---|
| | 10 | 10 | 10 | 9 | 8 | 8 | 9 | 10 | 10 |
| Bit Plane: | 0 | 1 | 1 | 0 | 0 | 1 | 0 | 0 | 1 |
| Value Stored: | 10 | | | 9 | 8 | | 9 | 10 | |

Using RCC, the data sequence is able to be compressed by 32% in this example.

However, further compression is desirable.

### SUMMARY OF THE INVENTION

In a first preferred aspect, there is provided a method for compressing image data of an image wherein the difference between each element and a previous element is calculated, the method comprising:
comparing the difference with a predetermined correlation value and:
   if they are equal, a first value is recorded; and
   V they are not equal, a second value is recorded.

The first and second values may be recorded in a bit plane.

If first value is recorded, the value of the element may not be stored, and if the second value is recorded, the value of the element may be stored.

The method may further comprise associating the predetermined correlation value with the bit plane.

The predetermined correlation value may be a value from −8 to +8.

The method may further comprise repeating the comparison of the difference for each predetermined correlation value, and where a separate bit plane is used for each predetermined correlation value.

The first value may be 1 and the second value may be 0.

Each element may be a pixel.

The method may further comprise the initial step of:
comparing each image element with a previous image element and if they are within a predetermined range of each other, modifying the image element to be equal to the previous image element;
where repetition is increased to enable lossy compression of the image.

The comparison may be performed in raster order, from left to right and then top to bottom.

The comparison may be performed in non-raster order, the comparison being one from the group consisting of: vertical and diagonal.

The method may further comprise transforming the image data according to any one from the group consisting: Repetition Coded Compression (RCC), Repetition Coded Compression Predict (RCCP), Repetition Coded Adaptive (RCCA), and Repetition Coded Compression Multidimensional.

The method may further comprise dividing the image into a plurality of tiles.

The method may further comprise streaming the tiles via a network.

In a second aspect there is provided a method for compressing data, the data comprising a plurality of data elements, wherein the difference between each element and a previous element is calculated, the method comprising:
comparing the difference with a predetermined correlation value and:
   if they are equal, a first value is recorded; and
   if they are not equal, a second value is recorded.

In a third aspect, there is provided a system for compressing image data of an image wherein the difference between each element and a previous element is calculated, the system comprising:
a comparison module to compare the difference with a predetermined correlation value, and if they are equal, a first value is recorded in a bit plane, and if they are not equal, a second value is recorded in the bit plane; and
an encoder to encode first and second values in the bit plane into a bit plane index;
wherein the compressed image is able to be decompressed using the bit plane index and the bit plane.

The compressed image and bit plane may be stored on a storage medium and the compressed image is stored as a plurality of tiles to enable streaming of the compressed image.

### BRIEF DESCRIPTION OF THE DRAWINGS

An example of the invention will now be described with reference to the accompanying drawings, in which:

FIG. 1 is an illustration of an 81-pixel region within a sample of a colour image;

FIG. 2 is a graph illustrating the distribution of correlation values for a typical colour image;

FIG. 3 is a process flow diagram of Repetition & Correlation Coding in accordance with a preferred embodiment of the present invention; and

FIG. 4 is a system architecture diagram of the Repetition & Correlation Coding system in accordance with a preferred embodiment of the present invention.

### DETAILED DESCRIPTION OF THE DRAWINGS

The drawings and the following discussion are intended to provide a brief, general description of a suitable computing environment in which the present invention may be implemented. Although not required, the invention will be described in the general context of computer-executable instructions, such as program modules, being executed by a computer such as a personal computer, laptop computer, notebook computer, tablet computer, PDA and the like. Generally, program modules include routines, programs, characters, components, data structures, that perform particular tasks or implement particular abstract data types. As those skilled in the art will appreciate, the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Image data is highly correlated. This means that more often than not, adjacent data values in an image are repetitive in nature. If they are not repetitive, then more often than not they are related to each other in some manner.

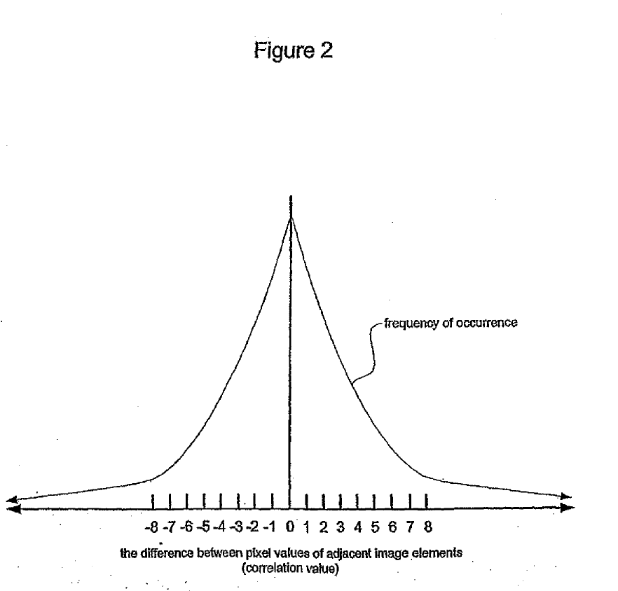

In 8 bit grayscale images, pixel values range from 0 to 256 to provide 256 distinct levels of gray. Each pixel is represented by 8 bits. For colour images, pixel values range from 0 (black) to 255 (brightest red) to provide 256 distinct levels of colour for an RGB image. There may be less repetition in a colour image but there remains a significant correlation between adjacent pixel values. It has been discovered that the difference between adjacent pixel values falls mostly within a limited range as illustrated in FIG. 2.

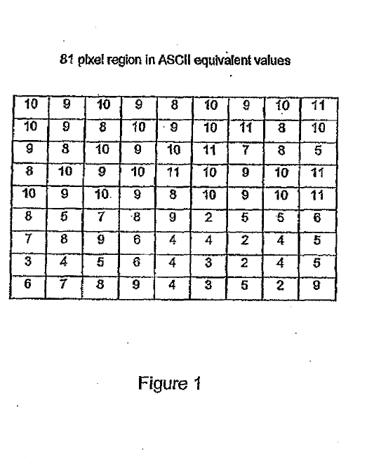

Referring to FIG. 1, the top row of the data sequence of the pixel region is used an example.

| | | | | | | | | | |
|---|---|---|---|---|---|---|---|---|---|
| Data Sequence: | 10 | 9 | 10 | 9 | 8 | 10 | 9 | 10 | 11 |

If RCC is applied:

| | | | | | | | | | |
|---|---|---|---|---|---|---|---|---|---|
| Bit Plane: | 1 | 1 | 1 | 1 | 1 | 1 | 1 | 1 | 1 |

| | | | | | | | | | |
|---|---|---|---|---|---|---|---|---|---|
| Value Stored: | 10 | 9 | 10 | 9 | 8 | 10 | 9 | 10 | 11 |

As there are no repetitions in the data sequence, RCC is not effective as all values need to be stored.

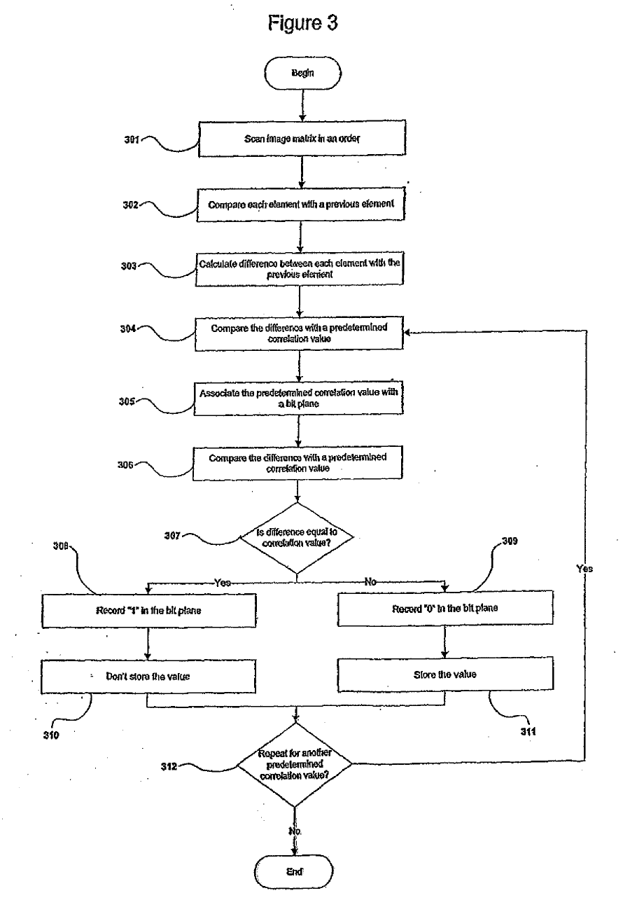

Referring to FIG. 3, a method for Repetition & Correlation Coding is provided. The pixels are scanned 301 in the horizontal direction (raster order) in the image matrix. Each element and its previous element are compared 302. The difference between an element and its previous element is calculated 303 by subtracting the value of the element from the value of its previous element. For the first element in the data sequence, no calculation is performed and its value is recorded.

Using the example of FIG. 1, the data sequence and correlation between adjacent elements are:

| | Data Sequence: | | | | | | | | |
|---|---|---|---|---|---|---|---|---|---|
| | 10 | 9 | 10 | 9 | 8 | 10 | 9 | 10 | 11 |
| Correlation: | 10 | −1 | +1 | −1 | −1 | +2 | −1 | +1 | +1 |

Next, a correlation value is selected for this first scan to be compared 304 with the correlation or difference between adjacent elements. For example, the first scan is performed with a correlation value of +1. The correlation value is associated 305 with a bit plane. The bit plane is not an indication of pixel value. A comparison 306 is performed between the correlation of adjacent elements in the data sequence and the correlation value. If the correlation and correlation value are equal 307 then a 1 is recorded 308 in the bit plane. Otherwise a 0 is recorded 309 in the bit plane.

| Bit Plane (+1): | | | | | | | | |
|---|---|---|---|---|---|---|---|---|
| 0 | 0 | 1 | 0 | 0 | 0 | 0 | 1 | 1 |

| | | | | | | |
|---|---|---|---|---|---|---|
| Value Stored: | 10 | 9 | 9 | 8 | 10 | 9 |

During encoding, the data sequence is encoded by storing 311 the value of the element where there is a 0 in the bit plane for that position and where there is a 1 in the bit plane, no value is stored 310.

Rather then storing 9×8=72 bits for the data sequence, only 6×8 bits=48 bits are stored +9 bits for the bit plane to code the correlation of values. Thus, the compression achieved is (72−57)÷72=21%.

A second scan is performed 312 with a correlation value of −1:

| | Bit Plane (−1): | | | | | | | | |
|---|---|---|---|---|---|---|---|---|---|
| | 0 | 1 | 0 | 1 | 1 | 0 | 1 | 0 | 0 |
| Value Stored: | 10 | | 10 | | | 10 | | 10 | 11 |

Rather than storing 9×8 bits=72 bits for the data sequence, only 5×8 bits are stored +9 bits for the bit plane to code the correlation of values. Thus, the compression achieved is (72−49)+72=32%.

For each scan, a separate bit plane is used. The difference between adjacent pixel values falls mostly within the range −8 to +8. Thus, up to 16 bit planes may be used where the process is performed 16 times to cover each correlation value.

Where multiple bit planes are used, a multidimensional bit plane may be used to increase compressibility. Using the present example, the multidimensional bit plane performs a combination of the first and second bit planes. A binary addition or an “OR” operation is performed on the two bit planes and is stored as a lossless compressed multidimensional bit plane.

Using the same example above:

| | | | | | | | | | |
|---|---|---|---|---|---|---|---|---|---|
| Bit Plane (+1): | 0 | 0 | 1 | 0 | 0 | 0 | 0 | 1 | 1 |

| | | | | | | | | | |
|---|---|---|---|---|---|---|---|---|---|
| Bit Plane (−1): | 0 | 1 | 0 | 1 | 1 | 0 | 1 | 0 | 0 |

The multidimensional bit plane is:

| | | | | | | | | |
|---|---|---|---|---|---|---|---|---|
| 0 | 1 | 1 | 1 | 1 | 0 | 1 | 1 | 1 |

A “NOT” is performed between the multidimensional bit plane and the original image matrix. Both the “OR” and “NOT” operations maintain the integrity of the image data and preserves the lossless nature of the transform.

| | | | | | | | | | |
|---|---|---|---|---|---|---|---|---|---|
| Multidimensional bit plane: | 0 | 1 | 1 | 1 | 1 | 0 | 1 | 1 | 1 |

| | | | | | | | | | |
|---|---|---|---|---|---|---|---|---|---|
| After NOT operation: | 1 | 0 | 0 | 0 | 0 | 1 | 0 | 0 | 0 |

The multidimensional bit plane is a consolidated bit plane representation of all the bit planes created by comparing the image pixel data with the predetermined correlation value. Consequently, the entire range of bit planes (based on the range of predetermined correlation values) are represented in a reduced number of bit planes thereby further enhancing compressibility of the image data.

Thus, the original image data is decomposed to one or more bit planes and stored along with an index of the image. The reconstruction is performed losslessly using the index and the bit plane.

To decode, the bit plane is inspected. If there is a 0 stored in a position of the bit plane, then the value has been stored. This value is retrieved to reproduce the element for the original image matrix. If there is a 1 stored in a position of the bit plane, then no value has been stored. When there is no value stored, the correlation value associated with the bit plane is added to the previous element to determine the value for the current element in order to reproduce the original image matrix.

Using the example of FIG. 1 again, the encoded data is:

| Bit Plane (+1): | | | | | | | | |
|---|---|---|---|---|---|---|---|---|
| 0 | 0 | 1 | 0 | 0 | 0 | 0 | 1 | 1 |

| | | | | | | |
|---|---|---|---|---|---|---|
| Value Stored: | 10 | 9 | 9 | 8 | 10 | 9 |

After decoding:

| | | | | | | | | | |
|---|---|---|---|---|---|---|---|---|---|
| Data Sequence: | 10 | 9 | 10 | 9 | 8 | 10 | 9 | 10 | 11 |

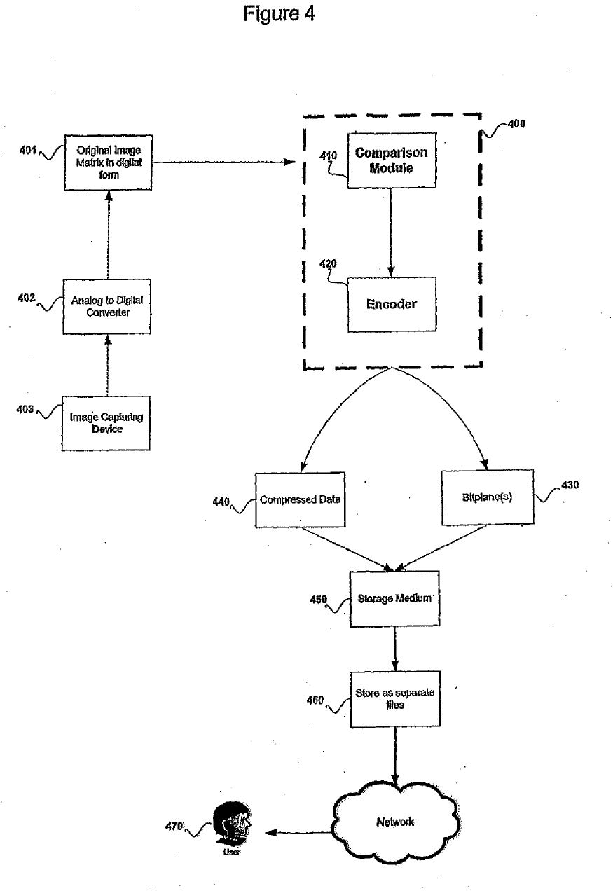

Referring to FIG. 4, an exemplary system 400 for compressing image data 401 of an image is provided. The difference between each element and a previous element is calculated by the system 400. The system 400 generally comprises a comparison module 410 and an encoder 420. The comparison module 410 compares the difference with a predetermined correlation value, and if they are equal, a first value is recorded in a bit plane 430, and if they are not equal, a second value is recorded in the bit plane 430. The encoder 420 encodes the first and second values in the bit plane 430 into a bit plane index, and compresses the image data. The compressed image 440 and bit plane 430 are stored on a storage medium 450. The compressed image 440 may be stored as separate files 460 to enable streaming of the image to users 470. The compressed image 440 is able to be decompressed using the bit plane index and the bit plane 430.

The image data may be sourced from an analog image capturing device 403 such as a still camera or video camera. If this is the case, an analog to digital converter 402 is required which may be a digital image scanner. Otherwise, if the image is already in digital form, it may be directly input to the comparison module 410 of the system 400.

Although a lossless system has been described, it is envisaged that lossy compression is possible. One way is by increasing repetition in the original image matrix. If the difference between adjacent pixels is less than a given arbitrary threshold value, then the adjacent pixels are made identical. This further increases the number of repetitions in the image data and therefore also increases the compression ratio after applying RCC. The value of the threshold can be varied according to the requirements of the particular application, and system. The higher the threshold, the better the compression ratio and also the higher the loss in the quality of the reconstructed image.

Also, RCC predict transformation (RCCP) and RCC adaptive transformation (RCCA) may be used together with the present invention to increase compressibility. RCCP and RCCA are disclosed in PCT/SG2004/000411, the contents of which are herein incorporated by reference.

Repetition & Correlation Coding may also be applied to streaming applications such as images displayed on a web page or mobile phone via MMS message. In streaming applications, the image is streamed via a network from an image source to a user. The image source may be a distributed database. In this application, the image may be divided into smaller tiles, each tile being transmitted in compressed form (after Repetition & Correlation Coding) to the user. Multiple tiles may be transmitted simultaneously by multiple servers to maximise bandwidth of the network. Initially, tiles are transmitted according to a predetermined scheme such as interlacing, or every fifth tile of the image is first transmitted, files are first transmitted incrementally from the center to the periphery of the image. Alternatively, the tiles to be first transmitted are selected at random. The transmission order continues in this manner unless interrupted by the user. The transmission of tiles is able to be intuitive and interactive whereby if the user selects a specific portion of the image they wish to zoom in on or inspect first, tiles within the selected portion are transmitted with a higher priority than other tiles of the image. Tiles adjacent to the selected portion are given the next priority, and the remaining tiles further away from the selected portion are given a lower priority. Therefore the transmission of ties to the user is ordered according to a priority determined by the selection or action of the user. Thus the relevant portion of the image which is of interest to a user is reproduced faster for display in contrast to conventional methods where the image typically is reproduced in raster order from left to right top to bottom. So, if the area of interest is located in the bottom right corner of the image the user has to wait for the entire transmission to complete.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

1-18. (canceled)

19. A method for increasing compressibility of image data of an image, the method comprising:
calculating a correlation between each image element and a previous image element;
comparing the correlation with a predetermined correlation value and:
if they are equal, a first value is recorded; and
if they are not equal, a second value is recorded.

20. The method according to claim 1, wherein the first and second values are recorded in a bit plane.

21. The method according to claim 1, wherein if the first value is recorded, the value of the image element is not stored, and if the second value is recorded, the value of the image element is stored.

22. The method according to claim 2, further comprising associating the predetermined correlation value with the bit plane.

23. The method according to claim 1, wherein the predetermined correlation value is a value from −8 to +8.

24. The method according to claim 5, further comprising repeating the comparison of the difference for each predetermined correlation value, and where a separate bit plane is used for each predetermined correlation value.

25. The method according to claim 1, wherein the first value is 1 and the second value is 0.

26. The method according to claim 1, wherein each image element is a pixel.

27. The method according to claim 1, further comprising the initial step of:
comparing each image element with a previous image element and if they are within a predetermined range of each other, modifying the image element to be equal to the previous image element;
where repetition is increased to enable lossy compression of the image.

28. The method according to claim 1, wherein the comparison is performed in raster order, from left to right and then top to bottom.

29. The method according to claim 1, wherein the comparison is performed in non-raster order, the comparison being one from the group consisting of: vertical and diagonal.

30. The method according to claim 1, further comprising transforming the image data according to any one from the group consisting: Repetition Coded Compression (RCC), Repetition Coded Compression Predict (RCCP), Repetition Coded Adaptive (RCCA), and Repetition Coded Compression Multidimensional (RCCM).

31. The method according to claim 1, further comprising dividing the image into a plurality of tiles.

32. The method according to claim 13, further comprising streaming the tiles via a network.

33. The method as claimed in claim 4, further comprising encoding repetitions in the bit plane into a bit-plane index, and encoding image data values of the image data, to form compressed data.

34. A method for increasing compressibility of data, the data comprising a plurality of data elements, the method comprising:
calculating a correlation between each data element and a previous data element;
comparing the correlation with a predetermined correlation value and:
if they are equal, a first value is recorded; and
if they are not equal, a second value is recorded.

35. A system for compressing image data of an image wherein a correlation between each image element and a previous image element is calculated, the system comprising:
a comparison module to compare the correlation with a predetermined correlation value, and if they are equal, a first value is recorded in a bit plane, and if they are not equal, a second value is recorded in the bit plane; and
an encoder to encode first and second values in the bit plane into a bit plane index;
wherein the compressed image is able to be decompressed using the bit plane index and the bit plane.

36. The system according to claim 17, wherein the compressed image and bit plane are stored on a storage medium and the compressed image is stored as a plurality of tiles to enable streaming of the compressed image.

37. A system for increasing compressibility of image data of an image, the system comprising:
means for calculating a correlation between each image element and a previous image element;
means for comparing the correlation with a predetermined correlation value; and
means for recording configured to record a first value if the correlation and the predetermined correlation value are equal, and record a second value if the if the correlation and the predetermined correlation value are not equal.

38. The system of claim 38, wherein the means for comparing is configured to perform the comparison in raster order, from left to right and then top to bottom.
